(19) United States
(12) Patent Application Publication
(10) Pub. No.: US 2009/0062067 A1
(43) Pub. Date: Mar. 5, 2009

(54) EXCESSIVE OIL TEMPERATURE INCREASE PREVENTION DEVICE FOR TORQUE CONVERTER OF AUTOMATIC TRANSMISSION

(75) Inventors: Masakatsu IWASE, Okazaki-city (JP); Shin-ichirou MURAKAMI, Okazaki-city (JP); Hiroshi TSUTSUI, Nishio-city (JP); Masahiko NISHIKAWA, Anjo-city (JP)

Correspondence Address: SUGHRUE MION, PLLC, 2100 PENNSYLVANIA AVENUE, N.W., SUITE 800, WASHINGTON, DC, 20037, US

(73) Assignee: AISIN AW CO., LTD, Anjo-shi (JP)

(21) Appl. No.: 12/201,600

(22) Filed: Aug. 29, 2008

(30) Foreign Application Priority Data
Aug. 30, 2007 (JP) 2007-224920

(51) Int. Cl. F16H 61/38; F16H 57/04

(52) U.S. Cl. 477/52

(57) ABSTRACT

An excessive oil temperature increase prevention device for a torque converter of an automatic transmission is provided wherein, if the per-unit-time heating value of the torque converter becomes greater than or equal to an upper limit value, then the automatic transmission is downshifted and an upshift is inhibited. An expected input shaft speed and an expected input torque after the upshift are calculated. An expected speed ratio and an expected capacity coefficient are also calculated. A per-unit-time expected heating value after the upshift is calculated using the expected input shaft speed, the expected speed ratio, and the expected capacity coefficient. When the per-unit-time expected heating value becomes less than or equal to a lower limit value, the inhibition of the upshift is cancelled.

### CROSS-REFERENCE TO RELATED APPLICATIONS

This application claims priority from Japanese Patent Application No. 2007-224920 filed on Aug. 30, 2007, the disclosure of which, including the specification, drawings and abstract, is incorporated herein by reference in its entirety.

### BACKGROUND

1. Technical Field

Devices consistent with the present invention relate to excessive oil temperature increase prevention for a torque converter of an automatic transmission, receiving an output from an engine via the torque converter, for a torque-converter-equipped vehicle, the device preventing an excessive temperature increase in hydraulic oil in the torque converter.

2. Description of the Related Art

Japanese Patent Application Publication No. JP-A-8-42660 describes the detection of excessive heat of a torque converter in an automatic transmission receiving a rotation of an engine via the torque converter. Referring to this document, a hydraulic oil temperature sensor detects temperature of hydraulic oil in the automatic transmission, an input shaft speed sensor detects an input shaft speed of the automatic transmission, and an engine speed sensor detects an engine speed. A difference is determined between a heating value of the torque converter during a predetermined time determined based on a speed ratio which is a ratio of the input shaft speed to the engine speed, the engine speed, and the performance diagram of the torque converter and a heat dissipation value from the torque converter during the predetermined time. Then, a temperature increase in hydraulic oil in the torque converter due to the difference is sequentially added to the temperature of the hydraulic oil detected by the sensor prior to the predetermined time. As a result, the temperature of the hydraulic oil in the torque converter is estimated.

If excessive heat in the torque converter is detected based on the estimated temperature of the hydraulic oil in the torque converter, then a shift line of a shift map of the automatic transmission is changed such that a lower shift speed is more likely to be selected. Alternatively, the lock-up line of the torque converter is changed such that the lock-up area is enlarged.

In order to change the shift line of the shift map of the automatic transmission such that the lower shift speed is more likely to be selected, or in order to change the lock-up line of the torque converter such that the lock-up area is enlarged, the shift line or the lock-up line must be set in accordance with each different characteristic of the torque converter and the engine. This process involves enormous efforts and a lot of time.

### SUMMARY

Exemplary embodiments of the present invention overcome the above disadvantages and other disadvantages not described above. Also, the present invention is not required to overcome the disadvantages described above, and exemplary embodiments of the present invention may not overcome any of the problems described above. Aspects of the present invention easily prevent an excessive temperature increase in hydraulic oil in a torque converter independently of characteristics of an engine and the torque converter by downshifting an automatic transmission when the heating value of the torque converter per unit time is equal to or more than an upper limit.

According to a first aspect of the present invention, an automatic transmission is downshifted from a higher shift speed to a lower shift speed and an upshift from the lower shift speed to the higher shift speed is inhibited, when the per-unit-time heating value of a torque converter calculated using an engine speed, an input shaft speed of the automatic transmission, and a relation of a speed ratio and a capacity coefficient of the torque converter during a travel at the higher shift speed becomes greater than or equal to an upper limit value after the temperature of hydraulic oil of the torque converter exceeds a control start temperature until the temperature becomes lower than or equal to the control end temperature lower than the control start temperature by the predetermined temperature.

The per-unit-time expected heating value of the torque converter after the upshift from the lower shift speed to the higher shift speed is calculated, and the inhibition of the upshift from the lower shift speed to the higher shift speed is cancelled when the per-unit-time expected heating value of the torque converter after the upshift becomes less than or equal to a lower limit value.

Accordingly, it becomes unnecessary to set a shift line of a shift map to adjust with each different characteristic of the torque converter and the engine with a large amount of effort and time to make it easier to select the lower shift speed, whereby an excessive increase of the temperature of the hydraulic oil in the torque converter can be prevented easily and at low cost regardless of the characteristic of the torque converter and the engine.

Further, since the per-unit-time expected heating value when the upshift to the higher shift speed is made is calculated during the travel at the lower shift speed and the upshift is inhibited while the per-unit-time expected heating value is greater than or equal to the lower limit value, an excessive increase of the temperature of the hydraulic oil in the torque converter can be reliably prevented.

According to a second aspect of the present invention, the expected input shaft speed and the expected input torque of the automatic transmission after the upshift to the higher shift speed is calculated from the engine speed, the engine torque, the input shaft speed of the automatic transmission, and the relation of the speed ratio and the torque ratio of the torque converter during the travel at the downshifted lower shift speed, and the expected speed ratio and the expected capacity coefficient are calculated based on the relation of the speed ratio with the torque ratio and the capacity coefficient of the torque converter using the expected input shaft speed and the expected input torque. The per-unit-time expected heating value of the torque converter after the upshift to the higher shift speed is calculated using the expected input shaft speed, the expected speed ratio, and the expected capacity coefficient, and the inhibition of the upshift from the lower shift speed to the higher shift speed is cancelled when the per-unit-time expected heating value of the torque converter after the upshift becomes less than or equal to the lower limit value, whereby an excessive increase of the temperature of the hydraulic oil in the torque converter can reliably be prevented.

According to a third aspect of the present invention, the relation of the per-unit-time expected heating value of the torque converter when the upshift is made to the higher shift speed and the per-unit-time heating value of the torque converter during the travel at the lower shift speed is obtained and stored in a storage in advance. The per-unit-time heating value of the torque converter during the travel at the lower shift speed is calculated from the engine speed, the input shaft speed of the automatic transmission, and the relation of the speed ratio and the capacity coefficient of the torque converter, and the per-unit-time expected heating value of the torque converter when the upshift to the higher shift speed is made is calculated from the relation of the per-unit-time expected heating value stored in the storage and the per-unit-time heating value.

Accordingly, a calculation load of calculating the per-unit-time expected heating value after the upshift to the higher shift speed can be reduced considerably.

According to a fourth aspect of the present invention, the estimated temperature of the hydraulic oil in the torque converter calculated using the per-unit-time heating value of the torque converter calculated from the engine speed, the input shaft speed of the automatic transmission, and the relation of the speed ratio and the capacity coefficient of the torque converter and the temperature of the hydraulic oil detected by the oil temperature sensor provided in the circulation circuit of the hydraulic oil of the torque converter is deemed as the temperature of the hydraulic oil of the torque converter, whereby the temperature of the hydraulic oil in the torque converter can be estimated accurately and an excessive increase of the temperature of the hydraulic oil in the torque converter can reliably be prevented.

According to a fifth aspect of the present invention, a downshift determination control unit causes the automatic transmission to downshift from the higher shift speed to the lower shift speed when the per-unit-time heating value of the torque converter becomes greater than or equal to the upper limit value and a driver depresses an accelerator, whereby the driver does not experience discomfort due to a sudden shift of the automatic transmission.

### BRIEF DESCRIPTION OF THE DRAWINGS

The aspects of the present invention will become more apparent by describing in detail exemplary embodiments thereof with reference to the accompanying drawings, in which:

FIG. 1 is a schematic view of an automatic transmission for a torque-converter-equipped vehicle provided with an excessive oil temperature increase prevention device for a torque converter according to an exemplary embodiment of the present invention;

FIG. 2 is a sectional view of a torque converter consistent with an exemplary embodiment of the present invention;

FIG. 3 is a view showing an operation table of a brake and clutch in each shift speed consistent with an exemplary embodiment of the present invention;

FIG. 4 is a block diagram showing an electronic control device consistent with an exemplary embodiment of the present invention;

FIG. 5 is a view showing a shift map consistent with an exemplary embodiment of the present invention;

FIG. 6 is a view showing an oil temperature calculation program consistent with an exemplary embodiment of the present invention;

FIG. 7 is a view showing a performance diagram of a torque converter consistent with an exemplary embodiment of the present invention;

FIGS. 8A and 8B are views showing an excessive oil temperature increase prevention program consistent with an exemplary embodiment of the present invention;

FIG. 9 is a timing chart showing an operation of the excessive oil temperature increase prevention device for the torque converter consistent with an exemplary embodiment of the present invention;

FIG. 10 is a timing chart in which a depression of an accelerator is recorded with an operation of the excessive oil temperature increase prevention device for the torque converter consistent with an exemplary embodiment of the present invention;

FIG. 11 is a table for obtaining a speed ratio E, a torque ratio K, and a capacity coefficient C of the torque converter with C×K/E² as an index consistent with an exemplary embodiment of the present invention;

FIG. 12 is a view showing a relation of a per-unit-time heating value dQ and a per-unit-time expected heating value dQp consistent with an exemplary embodiment of the present invention; and

FIG. 13 shows a schematic view of an electronic control device 43 consistent with an exemplary embodiment of the present invention.

### DETAILED DESCRIPTION OF EXEMPLARY EMBODIMENTS

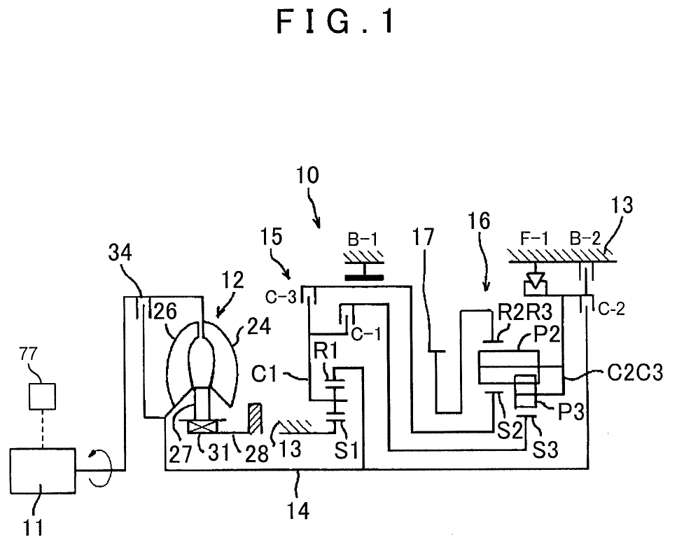

A first exemplary embodiment of the present invention is described below with reference to the drawings. In FIG. 1, reference numeral 10 denotes an automatic transmission, consistent with an exemplary embodiment of the present invention, which shifts an output rotation of a torque converter 12 rotationally driven by an engine 11 of an automobile and transmits the output rotation to a drive wheel (not shown). An accelerator 77 communicates with the engine 11. The automatic transmission 10 is comprised of an input shaft 14, a speed reduction planetary gear 15, a shifting planetary gear 16, an output shaft 17, first, second, and third clutches C-1, C-2, and C-3, first and second brakes B-1 and B-2, a one-way clutch F-1, and the like which are borne sequentially on a common shaft line in a transmission case 13 attached to a car body. The automatic transmission 10 enables each shift speed of six forward shift speeds and one reverse shift speed by selectively engaging/disengaging the first to third clutches C-1 to C-3 and the first and second brakes B-1 and B-2.

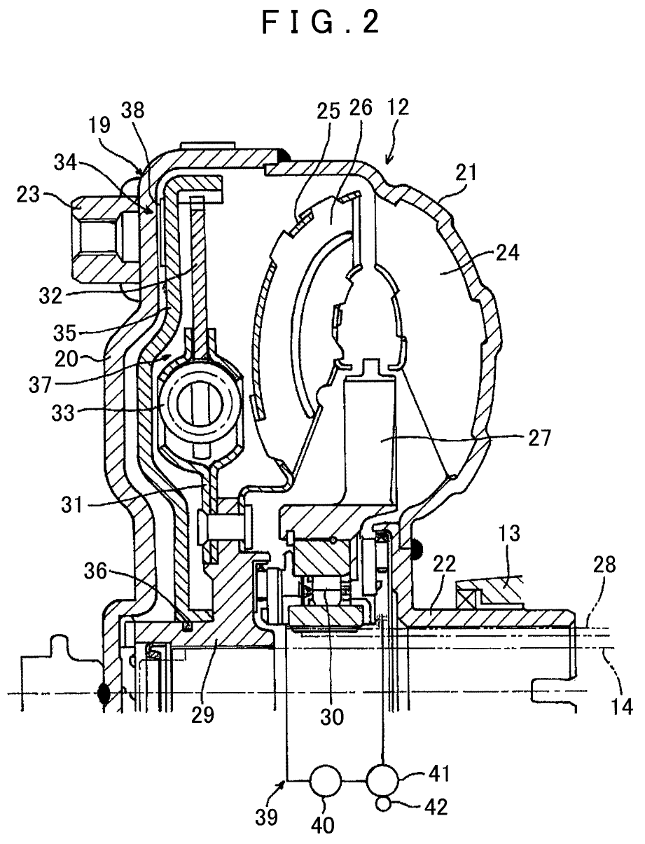

In FIG. 2, a housing 19 of the torque converter 12, consistent with an exemplary embodiment of the present invention, is comprised of a front cover 20, a pump shell 21, a flanged cylinder section 22, and the like joined integrally by welding, and is borne rotatably to the transmission case 13 by the flanged cylinder section 22. The housing 19 is connected with an output shaft of the engine 11 by a drive plate of the engine 11 being screwed to a set dog 23 provided to the front cover 20.

A pump impeller 24 is provided in an inner side of the pump shell 21, and faces a turbine 26 provided to a turbine wheel 25. The turbine wheel 25 is in contact with one side surface of a flange section of a connecting member 29 spline-engaged integrally with the input shaft 14, and is secured by a rivet to the connecting member 29 together with a spring holding plate 31, described later, which is in contact with another side surface. A stator 27 is arranged in a lower space between the pump impeller 24 and the turbine 26, and the stator 27 is secured to an outer race of a one-way clutch 30 and is borne by a thrust bearing between a flange inner side surface of the flanged cylinder section 22 and a side end surface of the connecting member 29. The input shaft 14 is borne rotatably by a needle bearing in an inner circumference of a stator shaft 28 secured to the transmission case 13, and an inner race of the one-way clutch 30 is spline-connected in an outer circumference. Accordingly, the pump impeller 24 is rotationally driven by the engine 11 to send out hydraulic oil to the turbine 26, and the stator 27 receives a reaction force of the hydraulic oil and transmits a rotational torque to the turbine 26.

A part of the hydraulic oil flows out from inside the torque converter 12, circulates in a circulation circuit 39 of the torque converter 12, and flows back in the torque converter 12. That is, the hydraulic oil that flows out from the torque converter 12 is, after being cooled by a cooler, pumped up by a hydraulic pump 40 rotationally driven by the engine 11, and pressure-controlled by a pressure control valve 41 to flow back to an inner diameter side of the pump shell 21. An oil temperature sensor 42 is provided inside a valve body of the pressure control valve 41, so that a temperature of the hydraulic oil supplied to the torque converter 12 is detected.

Reference numeral 35 denotes a piston of a lock-up clutch 34, which is sealed to a cylinder section of the connecting member 29 by a sealing member 36 to be engaged slidably. An enlarged section of the piston 35 extends in a radial direction facing an inner side surface of the front cover 20 of the housing 19, and a friction member 38 is adhered to a forward end surface portion facing a vicinity of an outer circumference of an inner end surface of the front cover 20. An outer edge section of the piston 35 and an outer circumference section of the connecting member 29 are connected via a damper device 37. The damper device 37 is arranged with the spring holding plate 31 connected with the connecting member 29 by the rivet and a plate 32 spline-engaged with the enlarged section of the piston 35 to be relatively rotatable, and is held in a neutral position by a spring force of a compression spring 33. When a pressure of the hydraulic oil pressure-controlled by the pressure control valve 41 to flow back to the inner diameter side of the pump shell 21, and consequently a pressure in the torque converter 12 increases, the lock-up clutch 34 causes the piston 35 to move forward to press the friction member 38 on the inner end surface of the front cover 20, and connects the housing 19 of the torque converter 12 connected with the output shaft of the engine 11 and the connecting member 29 spline-engaged with the input shaft 14 of the automatic transmission 10.

With reference to FIG. 1, in the speed reduction planetary gear 15 of the automatic transmission 10, a first ring gear R1 is connected with the input shaft 14, a first sun gear S1 is secured to the transmission case 13 to receive a reaction force, and a pinion borne by a first carrier C1 is meshed with the first ring gear R1 and the first sun gear S1. The shifting planetary gear 16 of the automatic transmission 10 is comprised of a second sun gear S2 having a large diameter, a third sun gear S3 having a small diameter, a long pinion P2 which directly meshes with the second sun gear S2 and meshes with the third sun gear S3 with a pinion P3 therebetween, a second carrier C2C3, which supports the long pinion P2 and the pinion P3, and a second ring gear R2R3 which meshes with the long pinion P2 and is connected with the output shaft 17.

The first carrier C1 of the speed reduction planetary gear 15 is connected with the third sun gear S3 of the shifting planetary gear 16 via the first clutch C-1 and is connected with the second sun gear S2 via the third clutch C-3. The second sun gear S2 of the shifting planetary gear 16 is connected with the first brake B-1, and the second carrier C2C3 is connected with the input shaft 14 via the second clutch C-2 and is connected in parallel with the one-way clutch F-1 and the second brake B-2 supported by the transmission case 13.

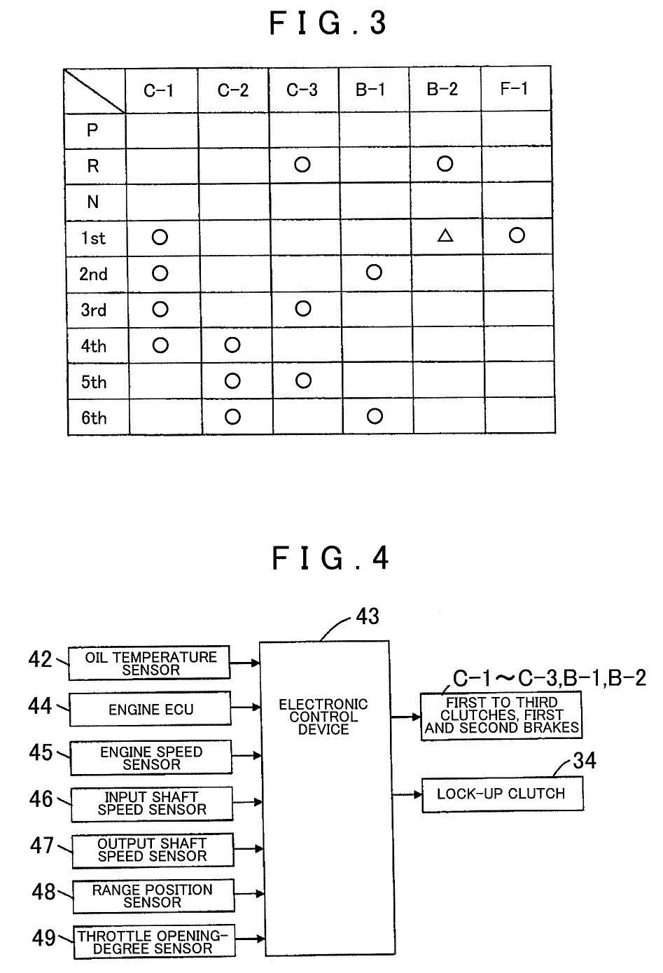

A relation of an engagement and release of each of the clutch, brake, and one-way clutch of the automatic transmission 10 with each shift speed, consistent with an exemplary embodiment of the present invention, is as shown in an engagement table of FIG. 3. A circle symbol shows the engagement, no symbol shows the release, and a triangle symbol shows the engagement only during an engine break in the engagement table.

As is clear from FIGS. 1 and 3, a first shift speed (1st) is achieved by the engagement of the first clutch C-1 and an automatic engagement of the one-way clutch F-1. A rotation of the first carrier C1, in which a rotation of the input shaft 14 is reduced in speed by the speed reduction planetary gear 15, is input to the third sun gear S3 of the shifting planetary gear 16 by the first clutch C-1, the second carrier C2C3 of which a reverse rotation is prevented by the one-way clutch F-1 receives a reaction force, and the second ring gear R2R3 is rotated at a reduced speed with a maximum gear ratio for an output to the output shaft 17.

A second shift speed (2nd) is achieved by the engagement of the first clutch C-1 and the first brake B-1. The rotation of the first carrier C1, in which the rotation of the input shaft 14 is reduced in speed by the speed reduction planetary gear 15, is input to the third sun gear S3 of the shifting planetary gear 16 via the first clutch C-1, the second sun gear S2 of which a rotation is prevented by the engagement of the first brake B-1 receives the reaction force, and the second ring gear R2R3 is rotated at a reduced speed of the second shift speed for the output to the output shaft 17. A gear ratio of the second shift speed is smaller than that of the first shift speed described above.

A third shift speed (3rd) is achieved by the engagement of the first and third clutches C-1 and C-3. The rotation of the first carrier C1, in which the rotation of the input shaft 14 is reduced in speed by the speed reduction planetary gear 15, is simultaneously input to the third and second sun gears S3 and S2 by the first and third clutches C-1 and C-3 to cause a directly connected state of the shifting planetary gear 16, and the second ring gear R2R3 is rotated with the same speed with that of the first carrier C1 for the output to the output shaft 17.

A fourth shift speed (4th) is achieved by the engagement of the first and second clutches C-1 and C-2. The rotation of the input shaft 14 is directly input to the second carrier C2C3 of the shifting planetary gear 16 by the second clutch C-2, the rotation of the first carrier C1, in which the rotation of the input shaft 14 is reduced in speed by the speed reduction planetary gear 15, is input to the third sun gear S3 of the shifting planetary gear 16 by the first clutch C-1, and the second ring gear R2R3 is reduced in speed to a speed in the middle of those of the input shaft 14 and the first carrier C1 for the output to the output shaft 17.

A fifth shift speed (5th) is achieved by the engagement of the second and third clutches C-2 and C-3. The rotation of the input shaft 14 is directly input to the second carrier C2C3 of the shifting planetary gear 16 by the second clutch C-2, the rotation of the first carrier C1, in which the rotation of the input shaft 14 is reduced in speed by the speed reduction planetary gear 15, is input to the second sun gear S2 of the shifting planetary gear 16 by the third clutch C-3, and the second ring gear R2R3 is rotated with an increased speed of the fifth shift speed for the output to the output shaft 17.

A sixth shift speed (6th) is achieved by the engagement of the second clutch C-2 and the first brake B-1. The rotation of the input shaft 14 is directly input to the second carrier C2C3 of the shifting planetary gear 16 by the second clutch C-2, the second sun gear S2 of which the rotation is prevented by the engagement of the first brake B-1 receives the reaction force, and the second ring gear R2R3 is rotated at an increased speed of the sixth shift speed for the output to the output shaft 17.

A reverse speed (R) is achieved by the engagement of the third clutch C-3 and the second brake B-2. The rotation of the first carrier C1, in which the rotation of the input shaft 14 is reduced in speed by the speed reduction planetary gear 15, is input to the second sun gear S2 of the shifting planetary gear 16 via the third clutch C-3, the second carrier C2C3, of which a rotation is prevented by the engagement of the second brake B-2, receives a reaction force, and the second ring gear R2R3 is reversely rotated for the output to the output shaft 17.

An electronic control device 43, consistent with an exemplary embodiment of the present invention, is described with reference to a block diagram shown in FIG. 4. The electronic control device 43 is a so-called microcomputer which includes a CPU, a RAM, a ROM, and an input/output interface. The CPU processes an input signal according to a program stored in the ROM in advance while utilizing a temporary storage function of the RAM and sends out an output signal. That is, the electronic control device 43 receives each detection signal from the oil temperature sensor 42, which detects the temperature of the hydraulic oil supplied to the torque converter 12, an engine speed sensor 45, which detects an engine speed Ne of the torque converter 12, to which the rotation of the engine 11 is transmitted, an input shaft speed sensor 46, which detects an input shaft speed Ni of the input shaft 14, an output shaft speed sensor 47, which detects a speed Nv of the output shaft 17, a range position sensor 48, which sends out a detection signal D when a manual valve is shifted to a forward travel range D, a throttle opening-degree sensor 49 which detects a depression amount Ss of an accelerator, and the like, and performs a shift control which selectively engages the first, second, and third clutches C-1, C-2, and C-3, and the first and second brakes B-1 and B-2 for enabling each shift speed by automatically switching a gear speed of the automatic transmission 10 according to a travel state of a vehicle, a lock-up engagement control which controls an engagement state of the lock-up clutch 34, and the like.

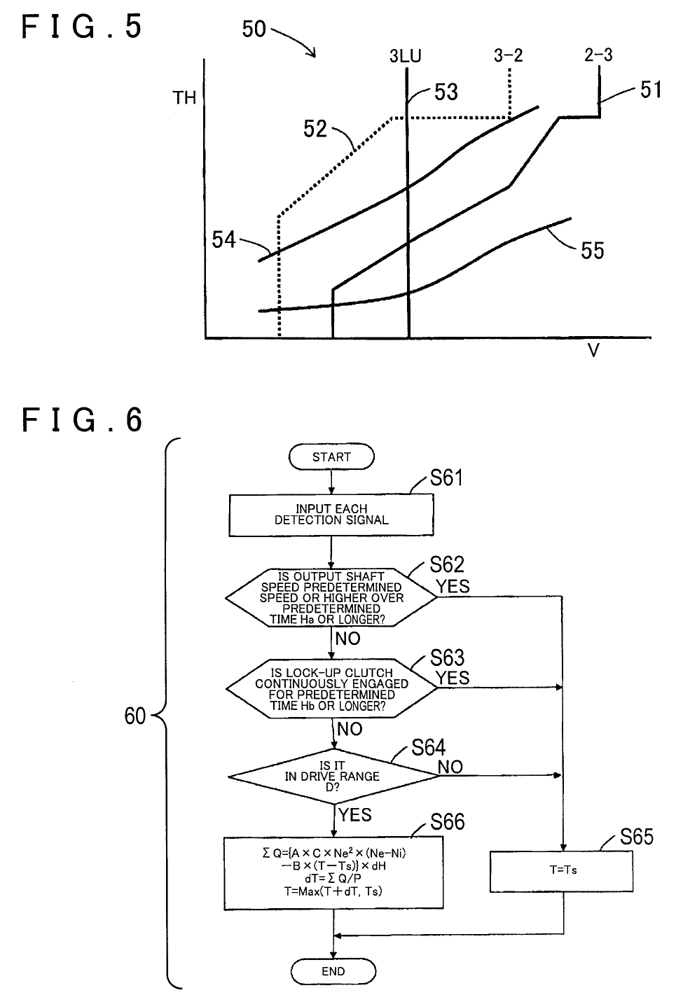

In the shift control, a shift speed preferable for a current driving state is obtained according to a shift line of a shift map set on a V-TH plane with a vehicle speed V obtained from the output shaft 17 detected by the output shaft speed sensor 47 as a horizontal axis and a throttle opening-degree TH detected by the throttle opening-degree sensor 49 as a vertical axis. In a shift map 50 consistent with an exemplary embodiment of the present invention, of which a part is shown in FIG. 5, a 2-3 upshift shift line 51 of an upshift from the second shift speed to the third shift speed at a normal time is shown by a solid line, and a 3-2 downshift shift line 52 of a downshift from the third shift speed to the second shift speed at the normal time is shown by a dotted line. Thus, the upshift from the second shift speed to the third shift speed is made along with a transition of a state of the vehicle speed and the throttle opening-degree from a left side region to a right side region of the 2-3 upshift shift line 51, and the downshift from the third shift speed to the second shift speed is made along with a transition from the right side region to the left side region of the 3-2 downshift shift line 52.

In the lock-up engagement control, the lock-up clutch 34 is engaged according to a lock-up line 53 set on the V-TH plane to connect a housing 19 of the torque converter 12 and the input shaft 14 of the automatic transmission 10. FIG. 5 shows the 3LU lock-up line 53, which shows the vehicle speed V when the lock-up clutch 34 is engaged in the third shift speed, in parallel with the vertical axis. Thus, the lock-up clutch 34 is engaged when the vehicle speed V makes a transition to a higher speed side than the 3LU lock-up line 53 in a state where the automatic transmission 10 has achieved the third shift speed, and is released when the vehicle speed V makes a transition to a lower speed side.

The electronic control device 43 repeatedly performs an oil temperature calculation program 60 consistent with an exemplary embodiment of the present invention shown in FIG. 6 at intervals of one task time dH and calculates an estimated temperature T of the hydraulic oil in the torque converter 12. The electronic control device 43 receives the speed Ne of the engine 11 detected by the engine speed sensor 45, the speed Ni of the input shaft 14 of the automatic transmission 10 detected by the input shaft speed sensor 46, the speed Nv of the output shaft 17 detected by the output shaft speed sensor 47, a temperature Ts of the hydraulic oil measured by the oil temperature sensor 42, and the detection signal sent out from the range position sensor 48 (operation S61), determines whether or not the output shaft speed Nv is a predetermined speed or higher over a continuous predetermined time Ha or longer (operation S62), determines whether or not the lock-up clutch 34 is continuously connected for a predetermined time Hb or longer (operation S63), and determines whether or not a shift to the drive range D is made (operation S64). When either one of the operations S62 and S63 is YES, or the operation S64 is NO, the estimated temperature T of the hydraulic oil in the torque converter 12 is deemed as the oil temperature Ts of the hydraulic oil detected by the oil temperature sensor 42 (operation S65). When the operations S62 and S63 are both NO, and the operation S64 is YES, the estimated temperature T of the hydraulic oil in the torque converter 12 is calculated in operation S66.

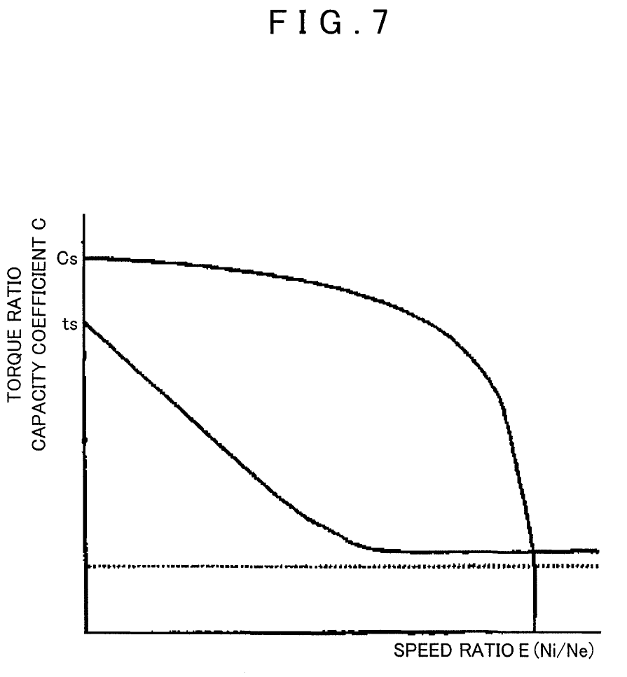

That is, the per-unit-time heating value dQ in the torque converter 12 is calculated with dQ=A×C×Ne²×(Ne−Ni) using a coefficient A that is relevant to watt [Joule)/sec] (e.g., containing heat capacity of the torque converter), the engine speed Ne, the input shaft speed Ni, and a relation of the speed ratio E (=Ni/Ne) and the capacity coefficient C of a performance diagram of the torque converter 12 consistent with an exemplary embodiment of the present invention as shown in FIG. 7. The per-unit-time heating value dQ is multiplied by the one task time dH to calculate the heating value in the torque converter 12 in the one task time dH. During the one task time dH, the hydraulic oil of the temperature Ts, at a start time of the one task time measured by the oil temperature sensor 42, provided in the circulation circuit 39, flows in the torque converter 12, and the hydraulic oil of the estimated temperature T flows out from inside the torque converter 12. Accordingly, a heat quantity emitted from inside the torque converter 12 during the one task time dH is B×(T−Ts)×dH with B being a setting value in consideration of a flow amount of the hydraulic oil circulating in the circulation circuit 39, specific heat of the hydraulic oil, and the like. Thus, a balance ΣQ of heat quantity coming in and out of the torque converter 12 during the one task time dH is shown as ΣQ={A×C×Ne²×(Ne−Ni)−B×(T−Ts)}×dH, and a change amount dT of the estimated temperature T during the one task time dH is shown as dT=ΣQ/P with P being a heat capacity of the hydraulic oil in the torque converter 12. The estimated temperature T in the torque converter 12 after a lapse of one task is a larger one of a value (T=T+dT), in which the estimated temperature T at the start time of one task is added with the change amount dT of the estimated temperature T during the one task time dH, and the oil temperature Ts of the hydraulic oil measured by the oil temperature sensor 42 at the lapse of one task. The performance diagram of FIG. 7 showing the relation of the speed ratio E (=Ni/Ne) with the capacity coefficient C and the torque ratio of the torque converter 12 is stored in the ROM of the electronic control device 43.

The oil temperature calculation program 60 may be executed by an oil temperature calculation unit, for example, which uses the per-unit-time heating value dQ of the torque converter 12 calculated from the engine speed Ne, the input shaft speed Ni of the automatic transmission 10, and the relation of the speed ratio E and the capacity coefficient C of the torque converter 12 and the temperature Ts of the hydraulic oil detected by the oil temperature sensor 42 to calculate the estimated temperature T of the hydraulic oil in the torque converter 12. An oil temperature detection unit which detects the temperature of the hydraulic oil of the torque converter 12 may be comprised by the oil temperature sensor 42 and an oil temperature calculation unit, which executes the oil temperature calculation program 60.

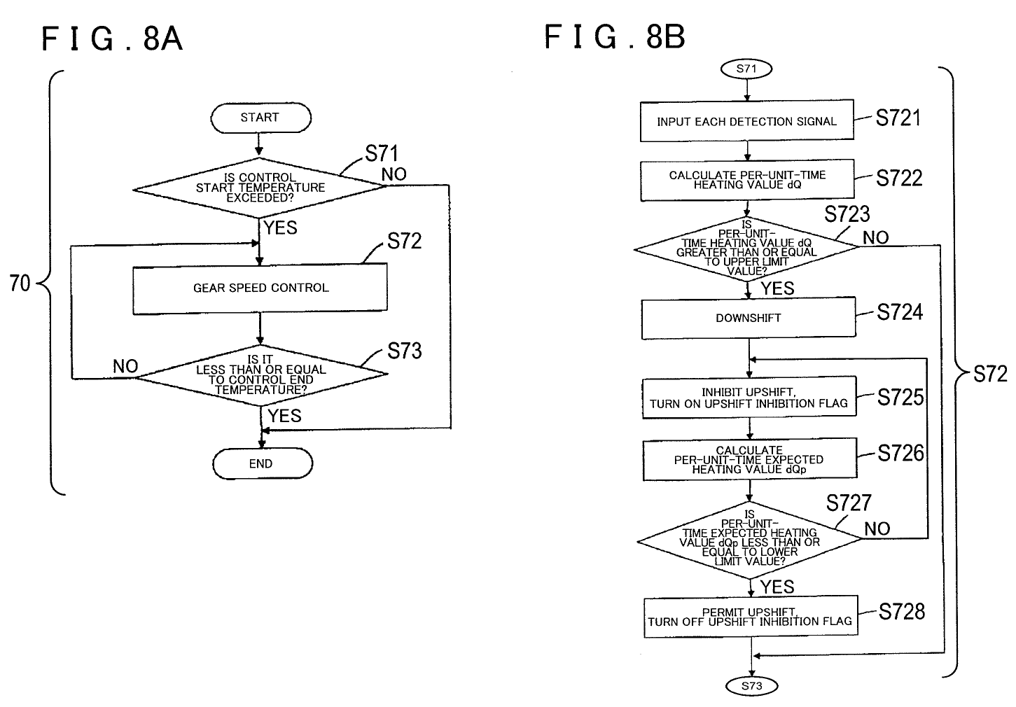

The electronic control device 43 repeatedly performs an excessive oil temperature increase prevention program 70 consistent with an exemplary embodiment of the present invention shown in FIGS. 8A and 8B at intervals of the one task time dH and prevents an excessive increase of the oil temperature of the hydraulic oil in the torque converter 12.

In the V-TH plane of FIG. 5, a heating value upper limit line 54 showing an upper limit value of the per-unit-time heating value dQ of the torque converter 12 and a heating value lower limit line 55 showing a lower limit thereof are drawn. When the estimated temperature T of the hydraulic oil in the torque converter 12 exceeds a control start temperature during travel at the third shift speed and the per-unit-time heating value dQ of the torque converter 12 becomes greater than or equal to an upper limit value before the estimated temperature T is less than or equal to a control end temperature, which is a predetermined temperature lower than the control start temperature, the automatic transmission 10 is downshifted from the third shift speed as a higher shift speed to the second shift speed as a lower shift speed, since there is a risk of the temperature of the hydraulic oil in the torque converter 12 rising excessively. That is, when the per-unit-time heating value dQ increases and a transition is made into a region encompassed by the heating value upper limit line 54, the 3-2 downshift shift line 52, and the 3LU lock-up line 53, the automatic transmission 10 is downshifted from the third shift speed to the second shift speed even if the vehicle speed V and the throttle opening-degree TH are on a third shift speed side with respect to the 3-2 downshift shift line 52, and the upshift from the second shift speed to the third shift speed is inhibited.

When the vehicle speed V and a drive torque Jo exerted to the output shaft 17 of the automatic transmission 10 are assumed to be the same as those during a travel at the second shift speed, the per-unit-time expected heating value dQp of the torque converter 12, when the upshift from the second shift speed to the third shift speed is made, is calculated, and a transition is made to a region in which the per-unit-time expected heating value dQp is smaller than the lower limit value of the heating value per unit time of the torque converter 12, an inhibition of the upshift from the second shift speed to the third shift speed is cancelled. Accordingly, when the transition is made to the region in which the per-unit-time expected heating value dQp is smaller than the lower limit value of the heating value per unit time of the torque converter 12, when the state of the vehicle speed V and the throttle opening-degree TH is in the right side region of the 2-3 upshift shift line 51, the upshift from the second shift speed to the third shift speed is made.

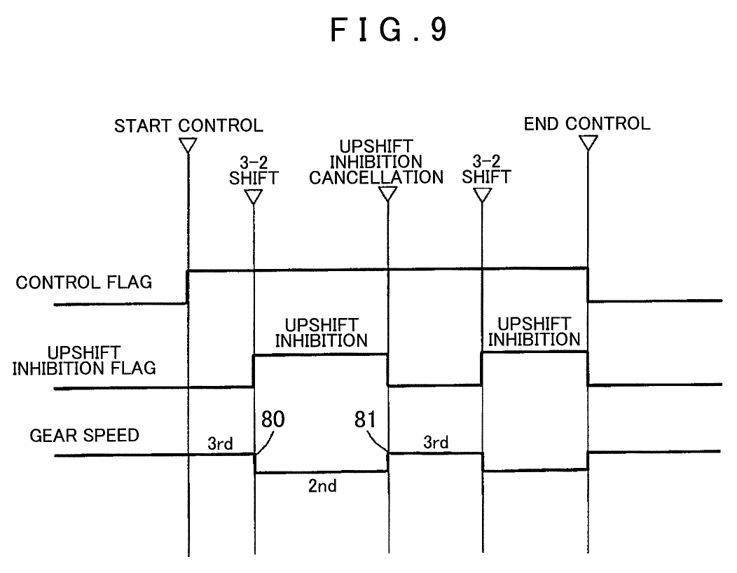

The electronic control device 43 determines whether or not the estimated temperature T of the hydraulic oil in the torque converter 12 calculated by the oil temperature calculation program 60 has exceeded the control start temperature (operation S71), and, when it is exceeded, a control flag is turned on and a gear speed control operation S72 is performed as shown in a timing chart of FIG. 9 (operation S72) until the estimated temperature T of the hydraulic oil becomes lower than or equal to the control end temperature which is lower by the predetermined temperature than the control start temperature (operation S73). The control end temperature, at which a gear speed control is ended, is set lower by the predetermined temperature as hysteresis than the control start temperature in order to prevent the gear speed control from being performed with hunting.

In the gear speed control operation S72, a detailed flow diagram of which is shown in FIG. 8B, the speed Ne of the engine 11 detected by the engine speed sensor 45, the speed Ni of the input shaft 14 of the automatic transmission 10 detected by the input shaft speed sensor 46, the speed Nv of the output shaft 17 detected by the output shaft speed sensor 47, and the temperature Ts of the hydraulic oil measured by the oil temperature sensor 42 are input (operation S721), and the per-unit-time heating value dQ of the torque converter 12 is calculated with dQ=A×C×Ne²×(Ne−Ni) (operation S722) using the engine speed Ne, the input shaft speed Ni, and the relation of the speed ratio E and the capacity coefficient C of the torque converter 12 shown in FIG. 7. When the per-unit-time heating value dQ becomes greater than or equal to the upper limit value (operation S723), the temperature of the hydraulic oil in the torque converter 12 soon rises excessively to an acceptance value or higher, whereby the automatic transmission 10 is downshifted from the third shift speed to the second shift speed (operation S724) as shown consistent with an exemplary embodiment of the present invention shown by a point 80 in the timing chart of FIG. 9 even if the downshift is not instructed on the shift map 50. At this time, an upshift inhibition flag is turned on to inhibit the upshift from the second shift speed to the third shift speed (operation S725).

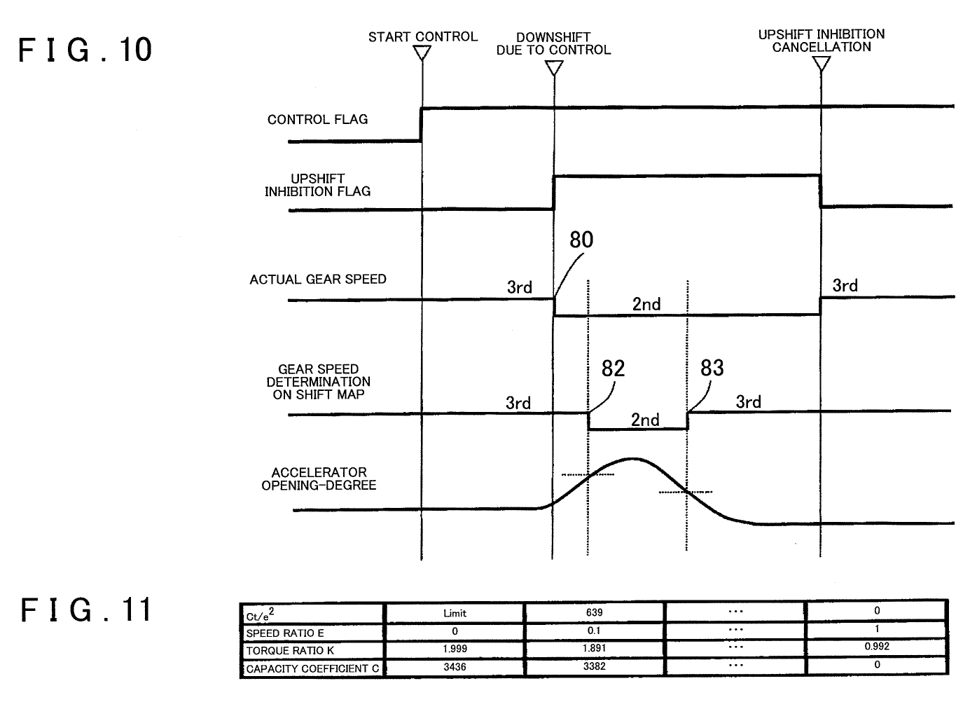

At a point 82 shown in a timing chart of FIG. 10, consistent with an exemplary embodiment of the present invention, a further downshift is not made even if the accelerator is depressed and it is judged as a downshift on the shift map, since the downshift from the third shift speed to the second shift speed is already made at the point 80. At a following point 83, the upshift is not made even if the accelerator is released and it is judged as the upshift on the shift map, since the upshift inhibition flag is turned on.

When the per-unit-time heating value dQ is less than the upper limit value in the operation S723, the gear speed control is ended without the downshift.

By the operations S721 and S722, a heating value calculation unit is structured, which calculates the per-unit-time heating value dQ of the torque converter 12 using the engine speed Ne, the input shaft speed Ni of the automatic transmission 10, and the relation of the speed ratio E and the capacity coefficient C of the torque converter 12 during travel at the higher shift speed.

By the operations S723, S724, and S725, a downshift control unit is structured, which causes the automatic transmission 10 to be downshifted from the higher shift speed to the lower shift speed and inhibits the upshift from the lower shift speed to the higher shift speed, when a detected temperature of the hydraulic oil in the torque converter 12 detected by the oil temperature detection unit 42 and an oil temperature detection unit executing the oil temperature calculation program 60, exceeds the control start temperature and the per-unit-time heating value dQ of the torque converter 12 becomes greater than or equal to the upper limit value until the detected temperature becomes lower than or equal to the control end temperature, which is lower by a predetermined temperature than the control start temperature.

During travel at the second shift speed downshifted in this manner, the electronic control device 43 calculates the per-unit-time expected heating value dQp of the torque converter 12 when the upshift from the second shift speed to the third shift speed is made (operation S726), assuming that the vehicle speed V and an output torque Jo output from the output shaft 17 of the automatic transmission 10 are the same as those during travel at the second shift speed. Therefore, an expected input shaft speed Nip and an expected input torque Jip of the automatic transmission 10 are first calculated. The expected input shaft speed Nip, when the upshift is made to the third shift speed, is obtained by multiplying the output shaft speed Nv of the output shaft 17 corresponding to the vehicle speed V in the current second shift speed by a gear ratio Gr3 in the third shift speed of the automatic transmission 10 with a formula Nip=Nv×Gr3/Gr2.

The expected input torque Jip is calculated based on an engine torque Je output by the engine 11 during the travel at the second shift speed. The engine torque Je is obtained by obtaining the capacity coefficient C at the speed ratio E (=Ni/Ne) at the time from the performance diagram of the torque converter 12 shown in FIG. 7, and multiplying the capacity coefficient C by a square of the engine speed Ne. That is, an input torque Ji in the current second shift speed is calculated from the relation of the speed ratio E and the torque ratio K (=Ji/Je) of the performance diagram of the torque converter 12 with a formula Ji=K×Je, and the output torque Jo is calculated by multiplying the input torque Ji by a gear ratio Gr2 in the second shift speed with a formula Jo=Ji×Gr2. Assuming that the output torque Jo does not change even if the upshift to the third shift speed is made, the expected input torque Jip in the third shift speed is obtained by dividing the output torque Jo by the gear ratio Gr3 in the third shift speed with a formula Jip=K×Je×Gr2/Gr3.

The engine torque Je may be input from an engine ECU 44, which controls the engine 11, to the electronic control device 43. The output shaft speed Nv of the output shaft 17 corresponding to the vehicle speed V in the current second shift speed may be obtained by dividing the input shaft speed Ni in the second shift speed by the gear ratio Gr2 in the second shift speed of the automatic transmission 10.

Assuming that the vehicle speed V and the output torque Jo exerted to the output shaft 17 of the automatic transmission 10 are the same as those during the travel at the second shift speed, the capacity coefficient C, the torque ratio K, and the speed ratio E of the torque converter 12 in the state where the upshift from the second shift speed to the third shift speed is made are obtained with C×K/E² as the index. A substitution of a formula Jip/Nip², in which the expected input torque Jip in the third shift speed is divided by a square of the expected input shaft speed Nip, with an expected capacity coefficient Cp=Jep/Nep², an expected speed ratio Ep=Nip/Nep, and an expected torque ratio Kp=Jip/Jep, results in Jip/Nip²=Cp×Kp/Ep², whereby the Cp×Kp/Ep² in the third shift speed can be obtained by dividing the expected input torque Jip by the square of the expected input shaft speed Nip. The C×K/E² of the torque converter 12 is calculated in advance based on the performance diagram of FIG. 7 and is stored in the ROM as a table consistent with an exemplary embodiment of the present invention as shown in FIG. 11.

The Cp×Kp/Ep² in the third shift speed is calculated by a substitution of Jip/Nip² with the expected input torque Jip (=Ji×Gr2/Gr3) and the expected input shaft speed Nip (=Nv×Gr3) with Ji×Gr2/Nv²×Gr3³, and the expected speed ratio Ep and the expected capacity coefficient Cp in the third shift speed are obtained from a table 10 with a value of the Cp×Kp/Ep² as an index. An expected engine speed Nep is calculated from the expected speed ratio Ep with Nep=Nip/Ep.

The per-unit-time expected heating value dQp of the torque converter 12 when the upshift is made from the second shift speed to the third shift speed is calculated with a formula dQp=A×Cp×Nep²×(Nep−Nip) (operation S726), and when the per-unit-time expected heating value dQp becomes less than or equal to the lower limit value of the heating value per unit time of the torque converter 12, the upshift inhibition flag is turned off to cancel the inhibition of the upshift from the second shift speed to the third shift speed (operation S727) as shown by the point 81 in the timing chart of FIG. 9. Thus, in a region on a right side of the 2-3 upshift shift line 51 and a left side of the 3LU lock-up line 53 shown in FIG. 5, the upshift inhibition flag is turned off whereby the automatic transmission 10 downshifted to the second shift speed is upshifted to the third shift speed, when the per-unit-time expected heating value dQp decreases and becomes less than or equal to the heating value lower limit line 55. When the per-unit-time expected heating value dQp becomes less than or equal to the heating value lower limit line 55 between the 2-3 upshift shift line 51 and the 3-2 downshift shift line 52, the upshift inhibition flag is turned off, but the automatic transmission 10 downshifted to the second shift speed is not upshifted to the third shift speed. In the case where the vehicle speed V rises above the 3LU lock-up line 53 when the per-unit-time expected heating value dQp is between the heating value upper limit line 54 and the heating value lower limit line 55, the upshift inhibition flag is turned off whereby the automatic transmission 10 downshifted to the second shift speed is upshifted to the third shift speed if the driving state is in the right side region of the 2-3 upshift shift line 51, and the automatic transmission 10 downshifted to the second shift speed is not upshifted to the third shift speed although the upshift inhibition flag is turned off if the driving state is in the left side region of the 2-3 upshift shift line 51.

It functions as the hysteresis between the heating value upper limit line 54 and the heating value lower limit line 55 for preventing a repeat of the downshift and the upshift, whereby the upshift is inhibited while the per-unit-time expected heating value dQp exceeds the lower limit value of the heating value per unit time.

By the operation S726, an expected heating value calculation unit is structured, which calculates the expected input shaft speed Nip and the expected input torque Jip of the automatic transmission 10 when the upshift is made to the higher shift speed in a state where the vehicle speed V and an output torque To of the automatic transmission 10 are the same as those during travel at the lower shift speed from the engine speed Ne, the engine torque Je, the input shaft speed Ni, and the relation of the speed ratio E, the torque ratio K and the capacity coefficient C of the torque converter 12 during the travel at the lower shift speed, calculates the expected speed ratio Ep and the expected capacity coefficient Cp based on the relation of speed ratio E and the torque ratio K of the torque converter 12 using the expected input shaft speed Nip and the expected input torque Jip, and calculates the per-unit-time expected heating value dQp of the torque converter 12 after the upshift to the higher shift speed using the expected input shaft speed Nip, the expected speed ratio Ep, and the expected capacity coefficient Cp.

By the operations S727 and S728, an upshift inhibition cancellation unit is structured which cancels the inhibition of the upshift from the lower shift speed to the higher shift speed when the per-unit-time expected heating value dQp becomes less than or equal to the lower limit value.

In the exemplary embodiments described above, the expected input shaft speed Nip and the expected input torque Jip of the automatic transmission 10 in the third shift speed are calculated based on the engine torque Je, the output shaft speed Nv, and the performance diagram of the torque converter 12 in the second shift speed assuming that the vehicle speed V and the output torque Jo output from the output shaft 17 of the automatic transmission 10 when the upshift is made to the third shift speed are the same as those during the travel at the second shift speed, the expected speed ratio Ep, the expected torque ratio Kp, and the expected capacity coefficient Cp of the torque converter 12 after the upshift to the third shift speed are calculated based on the expected input shaft speed Nip, the expected input torque Jip, and the performance diagram of the torque converter 12, and the per-unit-time expected heating value dQp is calculated for each task time dH. Calculating the per-unit-time expected heating value dQp for each task time dH places considerable load on the electronic control device 43.

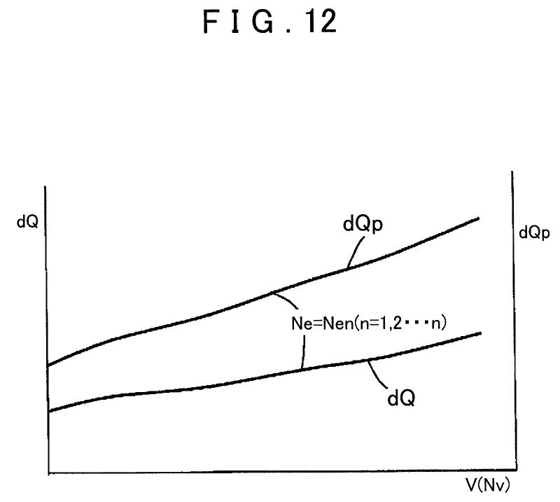

Therefore, for example, the per-unit-time heating value dQ in the case where the engine speed Ne in the second shift speed is a parameter and the output shaft speed Nv for each engine speed Ne is a variable, is calculated as described above. The per-unit-time expected heating value dQp in the third shift speed is calculated as described above with the output shaft speed Nv for each engine speed Ne as the variable, assuming that the vehicle speed V and the output torque Jo are the same as those during the travel at the second shift speed. As a result, it has been found that the per-unit-time expected heating value dQp approximates a value in which the per-unit-time heating value dQ for each output shaft speed Nv is multiplied by a coefficient U, in a region where the heating value per unit time is low, as shown in FIG. 12.

In another exemplary embodiment, the per-unit-time heating value dQ in the second shift speed and the per-unit-time expected heating value dQp in the third shift speed, assuming that the vehicle speed V and the output torque Jo are the same as those during travel at the second shift speed, are calculated in advance, and a relation thereof, for example, a coefficient of dQp=U×dQ is stored in the ROM of the electronic control device 43 in advance.

In the aforementioned exemplary embodiment, when the downshift from the third shift speed to the second shift speed is made (operation S724) and the upshift from the second shift speed to the third shift speed is inhibited (operation S725), the per-unit-time heating value dQ is calculated based on the engine speed Ne input for each task time dH, the output shaft speed Nv, and the performance diagram of the torque converter 12, and the per-unit-time expected heating value dQp is calculated by multiplying the per-unit-time heating value dQ by the coefficient U (operation S726). When the per-unit-time expected heating value dQp becomes less than or equal to the lower limit value of the heating value per unit time of the torque converter 12, the inhibition of the upshift from the second shift speed to the third shift speed is cancelled (operation S727). In this case, the per-unit-time expected heating value dQp is in the region in which comparison with the lower limit value is made, whereby an error falls within an acceptance range even if the per-unit-time expected heating value dQp is approximated with the formula dQp=U×dQ.

In the exemplary embodiments described above, although the downshift from the third shift speed to the second shift speed is made (operation S724) when the per-unit-time heating value dQ becomes greater than or equal to the upper limit value (operation S723), there are cases where a driver experiences discomfort with the downshift in a state where the accelerator is not depressed. Therefore, a downshift determination control unit may cause the automatic transmission 10 to downshift from the higher shift speed to the lower shift speed when the per-unit-time heating value dQ of the torque converter 12 becomes greater than or equal to the upper limit value and it is detected that the accelerator is depressed.

In the exemplary embodiments described above, the oil temperature detection unit which detects the temperature of the hydraulic oil of the torque converter is comprised of the oil temperature sensor 42, which is provided in the circulation circuit 39 of the hydraulic oil of the torque converter 12, and an oil temperature calculation unit which executes the oil temperature calculation program 60 which calculates the estimated temperature T of the hydraulic oil in the torque converter 12 using the per-unit-time heating value dQ of the torque converter 12 calculated from the engine speed Ne, the input shaft speed Ni, and the performance diagram of the torque converter 12 and the temperature Ts of the hydraulic oil detected by the oil temperature sensor 42. However, the oil temperature detection unit may also be comprised of only the oil temperature sensor 42.

In an exemplary embodiment described above, the third shift speed is the higher shift speed and the second shift speed is the lower shift speed, but it suffices that the higher shift speed be a shift speed with a small speed reduction ratio and the lower shift speed be a shift speed with a large speed reduction ratio of the automatic transmission.

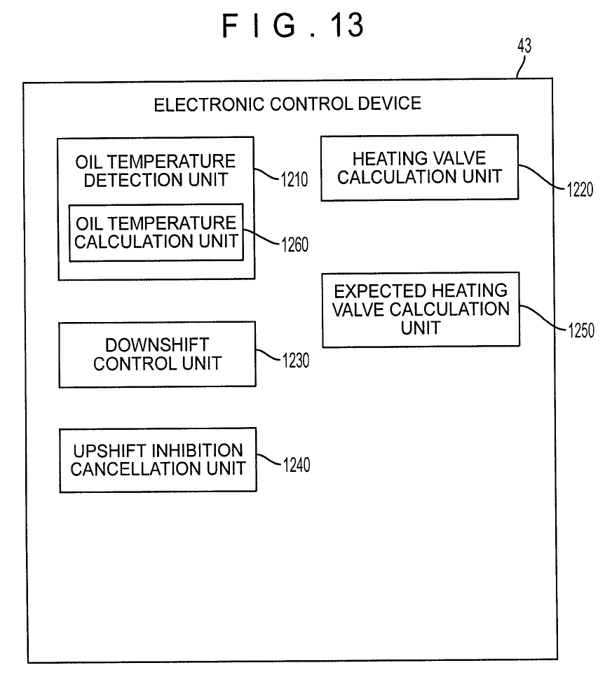

FIG. 13 shows a schematic view of an electronic control device 43 consistent with an exemplary embodiment of the present invention. As shown in FIG. 14, the exemplary electronic control device 43 comprises an oil temperature detection unit 1210, a heating value calculation unit 1220, a downshift control unit 1230, an upshift inhibition cancellation unit 1240 and an expected heating value calculation unit 1250. The oil temperature detection unit 1210 further comprises an oil temperature calculation unit 1260.

The excessive oil temperature increase prevention device for a torque converter of an automatic transmission for a torque-converter-equipped vehicle according to the present invention is suitable for use in an automatic transmission for a vehicle in which a rotation of an engine of an automobile is input to an input shaft via a torque converter and a rotation of the input shaft is shifted by an engagement/disengagement of a plurality of clutches and brakes to a plurality of shift speeds to be output to the output shaft.

It is contemplated that numerous modifications may be made to the exemplary embodiments of the invention without departing from the spirit and scope of the embodiments of the present invention as defined in the following claims.

What is claimed is:

1. An excessive oil temperature increase prevention device for a torque converter of an automatic transmission, the device comprising:
an oil temperature detection unit configured to detect a temperature of hydraulic oil of the torque converter;
a heating value calculation unit configured to calculate a per-unit-time heating value of the torque converter using an engine speed, an input shaft speed of the automatic transmission, and a relation between a speed ratio and a capacity coefficient of the torque converter during travel at a higher shift speed;
a downshift control unit configured to cause the automatic transmission to downshift from the higher shift speed to a lower shift speed and to cause an inhibition of an upshift from the lower shift speed to the higher shift speed, if:
a detected temperature of the hydraulic oil detected by the oil temperature detection unit exceeds a control start temperature;
the per-unit-time heating value calculated by the heating value calculation unit is greater than or equal to an upper limit value; and
the detected temperature of the hydraulic oil detected by the oil temperature detection unit is not lower than or equal to a control end temperature, wherein the control end temperature is lower than the control start temperature by a predetermined amount;
an expected heating value calculation unit configured to calculate a per-unit-time expected heating value of the torque converter after an upshift from the lower shift speed to the higher shift speed occurs; and
an upshift inhibition cancellation unit configured to cancel the inhibition of the upshift from the lower shift speed to the higher shift speed if the per-unit-time expected heating value calculated by the expected heating value calculation unit is lower than or equal to a lower limit value.

2. The excessive oil temperature increase prevention device for a torque converter of an automatic transmission according to claim 1, wherein the expected heating value calculation unit is configured to calculate an expected input shaft speed and an expected input torque of the automatic transmission when the upshift from the lower shift speed to the higher shift speed occurs in a state where a vehicle speed and an output torque of the automatic transmission are, respectively, identical to a vehicle speed and an output torque of the automatic transmission during travel at the lower shift speed,
wherein the expected heating value calculation unit is configured to calculate the expected input shaft speed and the expected input torque from an engine speed, an engine torque, an input shaft speed, and a relation of a speed ratio and a torque ratio of the torque converter during the travel at the lower shift speed,
wherein the expected heating value calculation unit is configured to calculate an expected speed ratio and an expected capacity coefficient based on the relation of the speed ratio and the torque ratio and the capacity coefficient of the torque converter, using the expected input shaft speed and the expected input torque, and
wherein the expected heating value calculation unit is configured to calculate a per-unit-time expected heating value of the torque converter after the upshift from the lower shift speed to the higher shift speed occurs using the expected input shaft speed, the expected speed ratio, and the expected capacity coefficient.

3. The excessive oil temperature increase prevention device for a torque converter of an automatic transmission according to claim 1, wherein the expected heating value calculation unit is configured to obtain and store a relation of the per-unit-time expected heating value of the torque converter when the upshift from the lower shift speed to the higher shift speed occurs in a state where a vehicle speed and an output torque of the automatic transmission are, respectively, identical to a vehicle speed and an output torque of the automatic transmission during travel at the lower shift speed, and a per-unit-time heating value of the torque converter during the travel at the lower shift speed,
wherein the expected heating value calculation unit is configured to calculate a per-unit-time heating value of the torque converter during the travel at the lower shift speed from an engine speed, an input shaft speed, and a relation of the speed ratio and the capacity coefficient of the torque converter, and
wherein the expected heating value calculation unit is configured to calculate the per-unit-time expected heating value of the torque converter when the upshift from the lower shift speed to the higher shift speed occurs from the stored relation of the per-unit-time expected heating value of the torque converter when the upshift from the lower shift speed to the higher shift speed occurs and the per-unit-time heating value of the torque converter during the travel at the lower shift speed.

4. The excessive oil temperature increase prevention device for a torque converter of an automatic transmission according to claim 1, wherein the oil temperature detection unit comprises:
an oil temperature sensor provided in a circulation circuit of the hydraulic oil of the torque converter; and
an oil temperature calculation unit configured to calculate an estimated temperature of the hydraulic oil in the torque converter using the calculated per-unit-time heating value of the torque converter and a temperature of the hydraulic oil detected by the oil temperature sensor.

5. The excessive oil temperature increase prevention device for a torque converter of an automatic transmission according to claim 1, wherein the downshift control unit causes the automatic transmission to downshift from the higher shift speed to the lower shift speed if the per-unit-time heating value of the torque converter is greater than or equal to the upper limit value and depression of an accelerator is detected.
